(19) United States
(12) Patent Application Publication
(10) Pub. No.: US 2025/0219416 A1
(43) Pub. Date: Jul. 3, 2025

(54) CALCULATION METHOD AND DEVICE FOR MULTI-SCALE ELECTRIC-CARBON ENERGY EFFICIENCY OPTIMIZATION CALCULATION METHOD AND DEVICE FOR POWER SYSTEM

(71) Applicants: Anhui Science and Technology University, Chuzhou (CN); Anhui Qiankun Electric Power Engineering Co., Ltd., Hefei (CN); Hefei University of Technology, Hefei (CN)

(72) Inventors: Yong CUI, Chuzhou (CN); Xinbo DAI, Chuzhou (CN); Kun XU, Chuzhou (CN); Minxue SHENG, Chuzhou (CN); Qian ZHENG, Chuzhou (CN); Guobao ZHANG, Chuzhou (CN); Lei XI, Chuzhou (CN); Jian ZHENG, Chuzhou (CN); Shuping ZHAO, Chuzhou (CN)

(21) Appl. No.: 19/085,204

(22) Filed: Mar. 20, 2025

Related U.S. Application Data
(63) Continuation of application No. PCT/CN2024/089619, filed on Apr. 24, 2024.

(30) Foreign Application Priority Data
Nov. 16, 2023 (CN) 2023115256556

(51) Int. Cl. H02J 3/06; H02J 3/38

(52) U.S. Cl. CPC H02J 3/06; H02J 3/381; H02J 2203/10; H02J 2203/20; H02J 2300/24

(57) ABSTRACT

The present application discloses a calculation method for multi-scale electric-carbon energy efficiency optimization for a power system, which includes designing a carbon flow calculation improvement model of the power system that takes into account a photovoltaic cluster auxiliary service, converting a power lossy transmission network of the power system equivalent to a lossless power consumption network, and calculating a carbon flow of the power system that takes into account a photovoltaic reactive power cluster auxiliary service; designing a decision-making system for low-carbon operation of the power system based on a coupling of electric-carbon energy efficiency, and calculating a correlation between electric quantity and the carbon flow of the power system that takes into account the photovoltaic cluster auxiliary service; the output varies in the range of 0-1, larger values represent a stronger correlation between electric-carbon energy efficiency.

### CROSS-REFERENCE TO RELATED APPLICATIONS

The present application is a continuation of International Application No. PCT/CN2024/089619, filed on Apr. 24, 2024, which claims priority to Chinese Patent Application No. 202311525655.6, filed on Nov. 16, 2023, the entire disclosure of which is incorporated herein by reference.

### TECHNICAL FIELD

The present application relates to the field of power information technology, and in particular to a calculation method and device for multi-scale electric-carbon energy efficiency optimization for a power system.

### BACKGROUND

Building a new type of power system is an effective way to realize the energy transition and achieve the goal of “double carbon”, and photovoltaic generation has become the main force of new energy generation and an important means of carbon reduction in the power system. The photovoltaic cluster can solve the problems of poor flexibility, insufficient risk resistance and limited support capacity of individual photovoltaic power station.

Based on the regulation capacity, carbon flow, energy efficiency and other indicators of photovoltaic power stations, a photovoltaic cluster division method coupled with carbon flow and energy efficiency is constructed, and then combined with the carbon flow and energy efficiency path coefficients to analyze the carbon flow and energy efficiency of system operation, to determine the photovoltaic clusters that have the greatest impact on the carbon flow and energy efficiency of the system, and the operation and control of the power system of hierarchical clusters are studied to formulate the control strategy of multi-photovoltaic cluster synergy, and various types of photovoltaic resources are mobilized to participate in the carbon reduction and enhancement efficiency of the system, for providing the large-scale development and utilization of renewable energy with key technical support and institutional mechanism guarantee, to help realize the goal of “double carbon”.

### SUMMARY

The present application provides a calculation method and device for multi-scale electric-carbon energy efficiency optimization for a power system, which is mainly aimed at improving the efficiency of multi-scale electric-carbon energy efficiency calculation for the power system.

According to a first aspect of the present application, a calculation method for multi-scale electric-carbon energy efficiency optimization for a power system includes:
designing a carbon flow calculation improvement model of the power system that takes into account a photovoltaic cluster auxiliary service, converting a power lossy transmission network of the power system equivalent to a lossless power consumption network, and calculating a carbon flow of the power system that takes into account a photovoltaic reactive power cluster auxiliary service;
designing a decision-making system for low-carbon operation of the power system based on a coupling of electric-carbon energy efficiency, and calculating and obtaining a correlation between electric quantity and the carbon flow of the power system that takes into account the photovoltaic cluster auxiliary service;
designing a method for classifying photovoltaic clusters that take into account the carbon flow and energy efficiency of the power system, and analyzing an impact of the photovoltaic cluster auxiliary service on the carbon flow and energy efficiency of the power system, calculating and obtaining a contribution of the photovoltaic cluster to carbon reduction and enhancement efficiency of the power system, to realize multi-scale carbon flow and energy efficiency optimization of the power system.

According to a second aspect of the present application, a calculation device multi-scale electric-carbon energy efficiency optimization for a power system includes:
a connection module, configured for connecting, interacting, and calculating information with the power system;
an acquisition module, configured for acquiring grid topology data, load data, photovoltaic power station data, acquiring a carbon flow of the power system that takes into account a photovoltaic cluster auxiliary service, lossless power consumption network conversion results, obtaining a decision-making system for low-carbon operation of the power system based on a coupling of electric-carbon energy efficiency, and obtaining a correlation between electric quantity and carbon flow of the power system that takes into account the photovoltaic cluster auxiliary service; obtaining a division result of the photovoltaic cluster that takes into account the carbon flow and energy efficiency of the power system, and obtaining a contribution of the photovoltaic cluster to carbon reduction and enhancement efficiency of the power system and a multi-scale carbon flow and energy efficiency optimization result of the power system;
a display module, configured for sending the multi-scale carbon flow and energy efficiency optimization result of the power system based on the photovoltaic power generation cluster model to a display terminal for displaying.

According to a third aspect of the present application, a calculation method for multi-scale electric-carbon energy efficiency optimization for a power system achieves the following steps:
obtaining the carbon flow of the power system considering the photovoltaic cluster auxiliary service;
designing a multi-scale operation scenario of the power system that takes into account the photovoltaic cluster auxiliary service, designing three operation scenarios of a photovoltaic inverter and a static var generator (SVG) device based on light intensity, calculating and obtaining changes in a dynamic carbon flow of the power system before and after 24 hours of division of the photovoltaic cluster, and analyzing a supporting role of the photovoltaic cluster auxiliary service in the low-carbon operation of the power system;
equivalently transforming the power lossy transmission network of the system power to the lossless power consumption network, apportioning network loss generated by a power network operation to each node load, combining a carbon emission intensity per unit power of different generating units, and constructing a power vector matrix of each unit, to calculate a dynamic network loss corresponding to carbon emissions generated by different paths of the power system, and to realize an accurate calculation of the carbon flow of the power system and obtain carbon indexes of various links of the power system, to track a carbon footprint of the power system, to achieve an equivalent transformation of lossy and lossless networks;
obtaining the carbon flow of the power system that takes into account the photovoltaic cluster auxiliary service, considering all branch trend distribution matrices, unit injection matrices, node flux matrices, carbon emission factors, real-time load values of nodes, and carbon emission intensity matrices of the generating units in the equivalent lossless network of the photovoltaic cluster auxiliary service, calculating and obtaining a carbon potential matrix of each node, to combine with equivalent node loads in the lossless power consumption network to calculate and obtain a carbon flow rate of loads and dynamic carbon emissions.

Obtaining a decision-making method for low-carbon operation of the power system based on a coupling of electricity-carbon energy efficiency;
calculating and obtaining a correlation between electrical quantity and carbon flow of the power system based on the photovoltaic cluster auxiliary service; wherein an output varies in a range of 0-1, a larger value represents a stronger correlation between electrical-carbon energy efficiency; based on an electric-carbon energy efficiency index, a low-carbon operation efficiency index system is constructed for the power system, which provides a basis for an identification of low-carbon operation efficiency of the power system and low-carbon operation decision-making; and
designing a data envelopment analysis (DEA) three-stage low-carbon operation decision-making method based on an input-output dynamic feedback, comprising a system low-carbon operation efficiency identification, an elimination of influence of external environmental variables on operation efficiency of the power system, and a low-carbon operation analysis of the power system based on a DEA dynamic loop feedback.

Obtaining the photovoltaic cluster that take into account the carbon flows and energy efficiency of the power system;
cluster classification indexes including: a regulation capacity of a photovoltaic generation system, a net load carbon flow rate, a node carbon potential, and a energy efficiency of the node;
the photovoltaic power generation system regulation capacity contains an upper and lower limits of a reactive power regulation capacity of the photovoltaic power generation system, a grid-connected capacity of the photovoltaic inverter, and the upper limit of the photovoltaic active regulation capacity;
a nodal net load is expressed as a difference between the node load correction value in the lossless equivalent network and an output value of a connected photovoltaic system, and the net load carbon flow rate is a product of the net load value and the node carbon potential;
dividing the photovoltaic system with close carbon potential of the nodes into the photovoltaic cluster, wherein the photovoltaic cluster is able to achieve a balanced distribution of carbon flows within the power system through the balancing of the node carbon potential, to effectively avoid the imbalance situation of carbon emissions;
dividing the photovoltaic power generation system with similar energy efficiency of the node into the photovoltaic cluster to fully understand the energy efficiency of each node in the photovoltaic cluster, to assist an energy planning of the power system and improve the overall energy utilization efficiency of the photovoltaic cluster;
establishing a node similarity matrix, photovoltaic access nodes within the same photovoltaic cluster having similar operating characteristics, by calculating and obtaining a similarity of the node's various indicators, to reflect a similarity of the operating characteristics of photovoltaic access nodes; and
using fast unfolding clustering algorithm for a division of photovoltaic clusters, using a modularity function as a basis for photovoltaic cluster division, wherein the larger the value of the modularity function, more reasonable results of the photovoltaic cluster division.

Analyzing the impact of the photovoltaic cluster auxiliary service on the carbon flow of the power system using structural equation modeling (SEM), and obtaining a degree of indirect impact of the photovoltaic cluster auxiliary service on the carbon flow and energy efficiency of the power system through other variables;
for the 24-hour operation data of the power system, analyzing a dynamic change law between a carbon flow path coefficient, a total energy efficiency path coefficient and a system load curve, which is capable of clarifying a supportive role mechanism of the photovoltaic cluster auxiliary service on the carbon flow and energy efficiency of the power system, and the contribution of each photovoltaic cluster to the carbon reduction and enhancement efficiency of the power system, and is capable of making clear an amount of adjustment of the photovoltaic cluster auxiliary service that improves the ability of the power system to operate in a low-carbon and high-efficiency manner.

The present application provides a multi-scale electric-carbon energy efficiency optimization calculation method and device for a power system based on a photovoltaic power generation cluster model, which, compared with the energy efficiency calculation and evaluation methods of the trend power system, can accurately measure the carbon measurement of the power system by obtaining the dynamic carbon flow of the power system taking into account the photovoltaic cluster auxiliary services; the three-stage electric-carbon energy efficiency of the DEA is obtained based on the dynamic feedback of the inputs and outputs, to eliminate the influence of the environmental or random errors on the accuracy of the system's low-carbon operational decision-making; the contribution of the photovoltaic generation cluster coupled with carbon flow and energy efficiency to the system's carbon reduction and efficiency is obtained, to clarify the mechanism of the photovoltaic cluster auxiliary service's influence on the carbon flow and energy efficiency of the power system. The present application reduces the difficulty of calculating electric-carbon energy efficiency, and thus improves the efficiency of calculating electric-carbon energy efficiency.

### BRIEF DESCRIPTION OF THE DRAWINGS

The accompanying illustrations herein are used to provide a further understanding of the present application and form part of this application, and the schematic embodiments of the present application and their description are used to explain the present application and do not constitute an improper limitation of the present application.

FIG. 1 is a flowchart of a calculation method for multi-scale electric-carbon energy efficiency optimization for a power system provided by embodiments of the present application;

FIG. 2 is a structural schematic diagram of a calculation device multi-scale electric-carbon energy efficiency optimization for a power system provided by embodiments of the present application.

### DETAILED DESCRIPTION OF THE EMBODIMENTS

In the following, the present application will be described in detail with reference to the accompanying drawings in conjunction with embodiments. It should be noted that the features in the drawings and embodiments of the present application may be combined with each other without conflict.

Currently, the low-carbon operation of the power system starts from the “source side” of the power system, and adopts optimization planning to reduce the direct carbon emissions of the power system, without considering the degree of the photovoltaic cluster auxiliary services supporting the power system to reduce carbon emissions, there resulting in a lower efficiency of calculating electric-carbon energy efficiency, and the error of calculating electric-carbon energy efficiency increases in the case of a larger photovoltaic penetration rate, which in turn results in a lower accuracy of calculating electric-carbon energy efficiency.

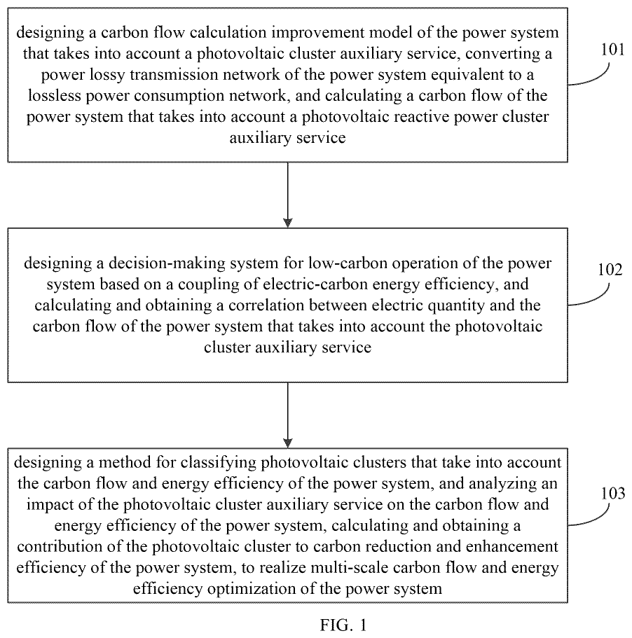

In order to solve the above problem, embodiments of the present application provide a multi-scale electric-carbon energy efficiency optimization calculation method for a power system based on a photovoltaic generation cluster model, as shown in FIG. 1, the method comprising:

101, obtaining the carbon flow of the power system that takes into account the photovoltaic cluster auxiliary service includes.

Step 1, obtaining a multi-scale operation scenario of the power system that takes into account the photovoltaic cluster auxiliary service.

Specifically, three operation scenarios of the photovoltaic inverters and static var generator (SVG) devices in the power system are considered. The first scenario: at 18:00-7:00, there is no light intensity, the active output of the photovoltaic system is 0, the remaining reactive capacity of the inverter reaches the maximum value, and at this period of time, the system reactive power support is carried out by the inverter alone; the second scenario: at 9:00-16:00, there is a strong solar illumination, and the photovoltaic system operates with full power, and at this period of time, the system reactive power support is carried out by the SVG device alone; the third scenario: at 7:00-9:00, 16:00-16:00, 16:00-16:00, 16:00-16:00, 16:00-16:00 and 16:00-16:00, the light intensity is weak, assuming that the photovoltaic power generation is running at 50% of the rated power, and at this period of time, the inverter and the SVG device collaborate to provide reactive power support to the power grid. The total reactive power support value of the photovoltaic power generation system is Q, and its active output value is the ratio pₚᵥ=Q/tan θ of the total reactive power support value and the tangent value of the phase angle of the access node of the photovoltaic power generation system. Based on the above three scenarios, respectively, the changes in the dynamic carbon flow of the power system before and after the division of the photovoltaic clusters in 24 hours are calculated and obtained, and the effect of the photovoltaic cluster auxiliary service supporting the carbon flow and the low-carbon operation of the system.

Step 2, equivalently transforming the power lossy transmission network of the system power to the lossless power consumption network.

In order to clarify the dynamic carbon emissions generated by the power system in the process of energy consumption and power generation transmission, the network loss generated by operation of the power grid operation is apportioned to each node load, combined with the carbon emission intensity per unit power of different generating units, and the power vector matrix of each generating unit is constructed, so as to measure the carbon emissions generated by the dynamic network loss of the system, to realize the accurate calculation of carbon emissions, and obtain the carbon indexes of the power system in each link. The carbon footprint of the power system can be effectively tracked.

Specifically, the equivalent conversion methods of lossy and lossless networks are as follows.

Equivalent trend calculation for each node of the lossless network.

The system trend of the lossy network through the trend calculation is obtained, and assuming that the N×N lossless network is equivalent to the actual lossy network, and the equivalent trend of each node of the lossless network is obtained; according to the classical trend tracking calculation method and its network topology characteristics, the node trend matrix is equal to the product of the injected power matrix of the generating unit and the downstream tracking matrix as shown in Eqs. (1)-(2).

$${P}_{G 1} + {P}_{X 1} = {A}_{u} {P}^{g} \qquad ( 1 )$$

$${A}_{u} = \{ \begin{matrix}1 & i = j \\ - \vert {P}_{j - i} \vert / {P}_{j} & j ∈ {a}_{i}^{( u )} \\ 0 & Others\end{matrix} \qquad ( 2 )$$

P^{g} denotes the active trend vector of each node of the system after equivalence to the lossless network, kW (the following active trends and load units are all kW); P_{G1} is an output vector of the generating unit; P_{X1}=[p_{1,pv}, . . . , p_{i,pv}]^{T} is the output vector of the photovoltaic cluster considering auxiliary services; Aᵤ is the order downstream tracking matrix, Pⱼ₋ᵢ is the active trend of the branch j-i in the actual lossy network flowing from the node j to the node i, Pⱼ is the active trend of the node flowing through the node in the actual lossy network, aᵢ^{(u)} is the active trend flowing into the nodes i of the node set.

Equivalent trend calculation for each branch of the lossless network.

Because the injected power of the generating unit is not affected by the network transformation, the injected matrix of the generating unit of the lossy network and the lossless network are equal, from which the equivalent trend of each node in the lossless network can be calculated and obtained; taking branch i-j as an example, due to the relatively small line loss, the ratio of the trend of branch i-j and node i in the lossless network is infinitely equal to the ratio of the trend of the branch i-j and node i in the lossy network, and therefore the trend of branch i-j in the equivalent lossless network is the product of the ratio of the trend of branch i-j to the trend of node i in the lossy network and the trend of node i in the lossless network, as in equation (3).

$${P}_{i - j}^{g} = \frac{{P}_{i - j}}{{P}_{i}} {P}_{i}^{g} \qquad ( 3 )$$

Pᵢ₋ⱼ^{g} is the active trend of the branch i-j in the equivalent lossless network flowing from node i to node i, Pᵢ is the active trend flowing through node i in the actual lossy network, and Pᵢ^{g} is the active trend flowing through node i in the equivalent lossless network.

Equivalent load calculation for nodes in the lossless network.

Taking node j as an example, according to the principle of equivalence ratio, the ratio of node j load to trend of the node i in the equivalent lossless network is equal to the ratio of node j load to trend of the node i in the actual lossy network, so the equivalent load of node j in the lossless network is the product of the product of the node j load over the trend of the node i in the lossy network after node j load over the trend of the node i and the trend of the node i in the lossless network as shown in equation (4).

$${P}_{Li}^{g} = \frac{{P}_{Li}}{{P}_{i}} {P}^{g} \qquad ( 4 )$$

P_{Li}^{g} is the correction amount of node i load at time t, and P_{Li} is the amount of integrated load of nodes i in the actual lossy network.

Step 3, obtaining the carbon flow of the power system taking into account the photovoltaic cluster reactive auxiliary service.

Specifically, all the branches of the trend distribution matrix in the equivalent lossless network considering the photovoltaic cluster auxiliary service are P_{B}, the injected matrix of the generating unit is P_{Z}, the flux matrix of the node is P_{N}, different generating units of carbon emission intensity matrix is E_{G}, the carbon potential matrix E_{N} of each node is calculated based on E_{N}=(P_{N}−P_{B}^{T})⁻¹P_{Z}^{T}E_{G}, where the carbon potential of the ith node is expressed as e_{Ni}; the load carbon flow rate R_{Li} is the carbon emissions generated per unit of time transferred from the generating side to the loads of each node, and R_{Li} is the value of the node load multiplied by the carbon emission intensity of the node; according to the existing carbon flow theory, the carbon emission intensity of the node load with electricity is equal to the carbon potential of the node, combined with the equivalent node load in the lossless network, the load carbon flow rate R_{Li}=P_{Li}^{g}e_{Ni} is calculated. The carbon emission factor η of the system is the ratio η=Σ(P_{Li}^{g}e_{Ni})/ΣP_{Li}^{g} of the carbon potential of all the nodes in the system to the sum of all the node loads, and the carbon emission factor is multiplied by the sum of real-time load of all the nodes in the power system to obtain the dynamic carbon emissions of the system at a certain time. In accordance with the method described above, the load carbon flow rate takes into account the influence of reactive auxiliary services, and includes the amount of carbon transfer generated by the network losses, which makes the calculation of the system carbon emission more accurate.

102, obtaining a decision-making system for low-carbon operation of a power system based on a coupling of electric-carbon energy efficiency includes:

Step 1, obtaining a correlation between the electrical quantity and carbon flow correlation of the power system considering the photovoltaic cluster auxiliary services.

Specifically, the carbon potential of the node, the load carbon flow rate, the dynamic carbon emission factor of the system, and the carbon emissions of the system are taken as carbon flow indicators, while the active energy consumption and the reactive energy consumption of the system, and the line loss rate are taken as core indicators of energy efficiency. Gray correlation analysis is used to verify the coupling relationship between electricity-carbon quantity and energy efficiency. Taking active energy consumption, reactive energy consumption, line loss rate as the characteristic sequence (independent variable), respectively, and taking dynamic carbon flow rate, system carbon emissions as the parent sequence (dependent variable), the model is constructed for simulation, and the variables are adjusted cyclically, and the output of its operation is the correlation value, which changes within the range of 0-1, and the larger the value, the stronger the correlation between electricity-carbon energy efficiency. A low-carbon operation efficiency index system for the power system is constructed based on the electricity-carbon energy efficiency index, which provides a basis for the identification of low-carbon operation efficiency of the system and low-carbon operational decision-making.

Step 2: obtaining the DEA three-stage low-carbon operation decision-making method based on input-output dynamic feedback.

The first stage: identifying the low-carbon operation efficiency of the system.

The corresponding hourly operating state of the system is taken as the decision-making unit (DMU) of the DEA model, while the real-time carbon flow rate of the nodes or carbon emissions of the system are taken as the input indexes of the DEA model, and the active energy consumption, reactive energy consumption, and line loss rate are taken as the output indexes of the DEA model; inputting the data of the input and output indexes into the DEA model can be calculated to derive the efficiency value of the decision-making unit, the input slack value S−, and the output slack value S+, and if the input slack value S− and the output slack value S+ are 0, it means that the decision-making unit reaches the optimal efficiency; if any slack value is greater than 0, it means that the decision-making unit is weak and effective, but there is still a certain space for efficiency improvement.

The second stage: eliminating the influence of external environmental variables on the operation efficiency of the system.

The operation efficiency is not only affected by decision-making units, but also by external environmental factors such as light intensity, ambient temperature and input random error of the system; on the basis of the first stage, with environmental factors, random error as independent variables, the input index slack value as the dependent variable, regression equations based on the stochastic frontier method (SFA) are constructed to eliminate the impact of environmental factors, random error on the efficiency of the system, in order to make each decision-making unit in a unified benchmark, effectively determining the operation efficiency of the system.

The third stage: obtaining the low-carbon operation efficiency of the system with DEA dynamic loop feedback.

For the non-DEA effective situation of the operation efficiency of the system, it means that the operation efficiency of the system is not qualified, and the third stage of DEA projection value analysis can be used to determine the redundancy amount of input elements, in order to determine the proportion of input indexes that need to be adjusted in the system, and the system dynamic operation efficiency analysis is carried out cyclically until the value of the operation efficiency of the system reaches the optimal; and based on the change rule of operation efficiency of the system, and combined with the electric-carbon index data of the system, the key links affecting the low-carbon operation efficiency of the system is analyzed, and lay the foundation for adjusting the operation of the system or the mode of photovoltaic cluster auxiliary service to achieve efficient decision-making.

103, obtaining photovoltaic clusters that take into account the carbon flow and energy efficiency of the power system, analyzing the impact of photovoltaic cluster auxiliary services on the carbon flow and energy efficiency of the power system, calculating and obtaining the contribution of the photovoltaic clusters to the carbon reduction and efficiency of the system, to realize the multi-scale optimization of the carbon flow and energy efficiency of the power system. The following steps are included.

Step 1, obtaining the cluster division index.

Obtaining regulation capacity of the photovoltaic power generation system.

Specifically, the regulation capacity reflects the regulation capacity of the photovoltaic generation system, and dividing photovoltaics with similar regulation capacity into a cluster is conducive to safeguarding the voltage security of the node. The regulation capacity is mainly divided into active regulation capacity and reactive regulation capacity. Each photovoltaic system within the cluster should have sufficient reactive regulation capacity to ensure that reactive power support is provided when power grid emergencies occur. When the power grid voltage exceeds the upper limit, the photovoltaic reactive output can be reduced to adjust the power grid voltage level; when the reactive regulation capacity exceeds the limit, the photovoltaic active output can be controlled to further ensure the safe operation of the power grid. The photovoltaic reactive Qⱼ and active regulation capacity Pⱼ are expressed in equations (5) and (6).

$${Q}_{j , min} \leq {Q}_{j} \leq {Q}_{j , max}$$

$$\{ \begin{matrix}{Q}_{j , min} = - \sqrt{{S}_{j , max}^{2} - {P}_{j}^{2}} \\ {Q}_{j , max} = \sqrt{{S}_{j , max}^{2} - {P}_{j}^{2}}\end{matrix} \qquad ( 5 )$$

$$0 \leq {P}_{j} \leq {P}_{j , max} \qquad ( 6 )$$

Q_{j,max} and Q_{j,min} are the upper and lower limits of the reactive power regulation capacity of the photovoltaic power generation system, kVar; S_{j,max} is the power grid-connected capacity of the photovoltaic inverter, kVA; P_{j,max} is the upper limit of the photovoltaic active regulation capacity, and the lower limit is zero.

Obtaining the net load carbon flow rate.

Specifically, in order to quantify the carbon reduction contribution of each photovoltaic power station to the power system, the photovoltaic power station will be made negative load treatment, the net node load is expressed as the difference between the modified value of the node load and the output of the connected photovoltaic system in the lossless equivalent network, and the net load carbon flow rate is the product of the value of the net load and carbon potential of the node as shown in Eq. (7), and the contribution of the different photovoltaic power stations to the reduction of carbon emissions in the power system is obtained.

$${R}_{Li , net} = ( {P}_{Li}^{g} - {P}_{i , pv} ) {e}_{Ni} \qquad ( 7 )$$

P_{i,net} is a net load of grid node i, P_{i,pv} is an active output of photovoltaic system at grid node i.

The carbon potential of the node is obtained.

Specifically, photovoltaic systems with close carbon potential of the nodes are divided into a cluster, and through the balance of carbon potential of the nodes, the photovoltaic clusters are able to achieve a balanced distribution of carbon flows within the power system, thus effectively avoiding the imbalance situation of carbon emissions. The reasonable maintenance of carbon potential of the node can help optimize the overall operation of the power system, ensuring that the photovoltaic clusters provide clean energy while coordinating with other forms of energy to jointly achieve the goal of decarbonizing the power system.

The energy efficiency of the node is obtained.

Specifically, the energy efficiency of the node can directly reflect the energy utilization efficiency of the photovoltaic cluster, and the photovoltaic generation systems with similar energy efficiencies of the nodes are divided into the photovoltaic cluster, to fully understand the energy efficiency of the nodes in the cluster, in order to assist in the energy planning of the power system, and to improve the overall energy utilization efficiency of the photovoltaic cluster.

Step 2, obtaining a similarity matrix of the nodes.

Specifically, by calculating and obtaining the similarity of the nodes of each indicator to reflect the similarity of the operation characteristics between the photovoltaic nodes, different clusters are divided into different units of indicators, it is necessary to normalize all the indicators before the division of the cluster to ensure that their ranges are between 0-1, as in equation (8).

$${{x}_{i , m}}^{′} = \frac{{x}_{i , m} - min ( {x}_{i , m} )}{max ( {x}_{i , m} ) - min ( {x}_{i , m} )} \qquad ( 8 )$$

x_{i,m}′ is the mth indicator value of the ith node after normalization, x_{i,m} is the mth indicator value of the ith node, max(x_{i,m}) is the maximum value of the mth indicator of node i, and min(x_{i,m}) is the minimum value of the mth indicator of node i.

The similarity matrix of the photovoltaic power generation system is calculated as shown in equation (9).

$$s ( i , j ) = \{ \begin{matrix}1 , & i = j \\ \frac{1}{A} {{\sum }^{n}}_{m = 1} {α}_{m} ( {{x}_{i , m}}^{′} \cdot {{x}_{j , m}}^{′} ) , & i \neq j\end{matrix} \qquad ( 9 )$$

$$A = {max}_{i \neq j} ( {{\sum }^{n}}_{m = 1} {α}_{m} ( {{x}_{i , m}}^{′} \cdot {{x}_{j , m}}^{′} ) )$$

where αₘ is the weight of the mth indicator and x_{i,m}′ and x_{j,m}′ are the normalized values of the mth indicator of the nodes i and j, respectively. Eq. (9) quantifies the similarity between the nodes of the photovoltaic power system, and the larger the inner product of the vectors, the more similar the nodes are.

Step 3, obtaining the optimal cluster division.

Specifically, the fast unfolding clustering algorithm is used for the division of clusters, which takes the modularity function as the basis for the division of clusters, and the larger the value of the modularity function Q is, the more reasonable the results of the division of clusters are. The module degree function is shown in equation (10).

$$Q = \frac{1}{2 m} {\sum }_{i} {\sum }_{j} [ {A}_{ij} - \frac{{k}_{i} {k}_{j}}{2 m} ] φ ( i , j ) , {k}_{i} = {\sum }_{j} {A}_{ij} , m = \frac{1}{2} {\sum }_{i , j} {A}_{ij} \qquad ( 10 )$$

Where Aᵢⱼ=1 when there is a connecting branch between nodes i and j, and Aᵢⱼ=0 when there is no connecting branch between nodes i and j; kᵢ is the number of all branches connected to node i; m is the number of all branches in the network. The function=1 if nodes i and j are in the same cluster, otherwise the function=0.

Based on the equivalent lossless network parameters, the photovoltaic power generation system and the load data, the division index values of the photovoltaic clusters are calculated and obtained, and the index values are normalized according to Eq. (8), and then the similarity value is obtained according to Eq. (9); each photovoltaic power node in the network is treated as the cluster individually, and Eq. (10) is used to calculate and obtain the value of modularity function at this time. The cluster of node i is randomly selected to form a new cluster with other clusters, the incremental value ΔQ′ of modularity function of the network is obtained, respectively, if ΔQ′ max>0, the cluster where node i is located is merged with the cluster corresponding to ΔQ′ max to form a new cluster, otherwise, no new cluster structure is formed. The formed cluster is used as a new node, and the similarity between the nodes is the sum of the similarity between two clusters, and the previous steps are repeated until the modularity function value Q′ of the whole network is no longer increasing, which is the optimal cluster division result.

Step 4, analyzing the impact of the photovoltaic cluster auxiliary service on the carbon flow of the system.

Specifically, H1 is auxiliary services, H2 is node carbon potential, H3 is node equivalent load, H4 is node load carbon flow rate, H5 is system dynamic carbon emission factor, H6 is system carbon emissions six indicators as latent variables, firstly, structural equation modeling (SEM) is used to test the degree of indirect influence of variable H1 on the dependent variable H4 through the intermediary variables of H2, H3, and the degree of direct influence of variable H1 on H5, H6; secondly, through the degree of influence between latent variables is tested by validated factor analysis, and the path coefficients H1-2, H1-3, H1-4, H2-4, H3-4, H1-5, H1-6 between latent variables can be calculated; the degree of the direct influence of photovoltaic cluster auxiliary services on the carbon flow of the system can be expressed by the path coefficients between the latent variables, and on the other hand, the degree of influence of photovoltaic cluster auxiliary services on the carbon flow of the system through the other variables can be obtained by the product of the path coefficients between the different latent variables (e.g., the indirect effect of H1 on H5 through H2 is H1-2*H2-5); the total influence effect is the sum of the direct and indirect effects, i.e., the carbon flow path coefficient HT, which expresses the total degree of influence of the photovoltaic cluster auxiliary services on the carbon flow of the system.

Step 4, analyzing impact of photovoltaic cluster auxiliary services on the energy efficiency of the system.

Specifically, H1 is auxiliary services, H4 is node load carbon flow rate, H6 is system carbon emissions, H7 is active energy consumption, H8 is reactive energy consumption, H9 is line loss rate, these six indicators are set as latent variables, the calculation process and method and step 3 are the same, and the total path coefficient of energy efficiency, HN indicates the degree of impact of photovoltaic cluster auxiliary services on the energy efficiency of the system.

Step 5, obtaining a multi-scale carbon flow energy efficiency optimization decision for the power system.

Specifically, with respect to the 24-hour operation data of the system, the dynamic change relationship and law between HT, HN and the system load curve are analyzed, it can be clarified that the support mechanism of photovoltaic cluster auxiliary services on the carbon flow and energy efficiency of the system, and the contribution of each photovoltaic cluster to the system to reduce carbon and increase the efficiency of the system, and it can clarify the amount of adjustments of the photovoltaic cluster auxiliary services to improve the system's ability to operate in a low-carbon and high-efficiency manner, which lays the foundation for realizing the high-efficiency decision-making of the system.

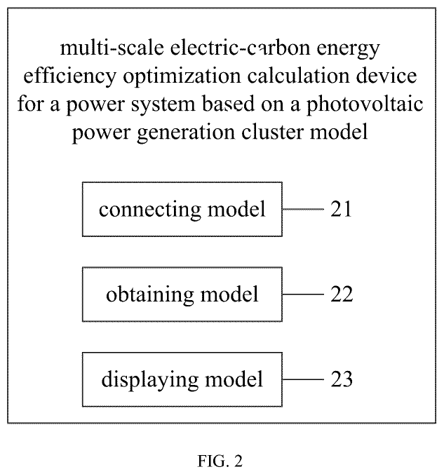

Further, as a specific realization of the method described in FIG. 1, embodiments of the present application provide a multi-scale electric-carbon energy efficiency optimization calculation device for a power system based on a photovoltaic power generation cluster model, as shown in FIG. 2, the device includes: a connection module 21, an acquisition module 22, and a display module 23;
the connection module 21, for connecting, interacting, and calculating information with the power system.
the obtaining module 22, for acquiring grid topology data, load data, photovoltaic power station data, acquiring a carbon flow of the power system that takes into account a photovoltaic cluster auxiliary service, lossless power consumption network conversion results, obtaining a decision-making system for low-carbon operation of the power system based on a coupling of electric-carbon energy efficiency, and obtaining a correlation between electric quantity and carbon flow of the power system that takes into account the photovoltaic cluster auxiliary service; obtaining a division result of the photovoltaic cluster that takes into account the carbon flow and energy efficiency of the power system, and obtaining a contribution of the photovoltaic cluster to carbon reduction and enhancement efficiency of the power system and a multi-scale carbon flow and energy efficiency optimization result of the power system;
the display module 23, for sending the multi-scale carbon flow and energy efficiency optimization result of the power system based on the photovoltaic power generation cluster model to a display terminal for displaying.

Those skilled in the art may understand the accompanying drawings as a schematic diagram of a preferred implementation scenario, and the modules or processes in the accompanying drawings are not necessarily necessary to implement the present application.

Those skilled in the art may understand the modules in the implementation scenario device as being distributed in the device according to the description of the implementation scenario, and one or more devices different from the present implementation scenario may be varied accordingly. The modules of the implementation scenarios described above may be combined into a single module or further split into a plurality of sub-modules.

The above serial numbers of this application are for descriptive purposes only and do not represent the merits of the implementation scenarios.

The above disclosure is only a specific implementation scenario of the present application, however, this application is not limited to this, and any variation that can be contemplated by those skilled in the art shall fall within the scope of protection of the present application.

What is claimed is:

1. A calculation method for multi-scale electric-carbon energy efficiency optimization for a power system, comprising:
designing a carbon flow calculation improvement model of the power system that takes into account a photovoltaic cluster auxiliary service, converting a power lossy transmission network of the power system equivalent to a lossless power consumption network, and calculating a carbon flow of the power system that takes into account a photovoltaic reactive power cluster auxiliary service;
designing a decision-making system for low-carbon operation of the power system based on a coupling of electric-carbon energy efficiency, and calculating and obtaining a correlation between electric quantity and the carbon flow of the power system that takes into account the photovoltaic cluster auxiliary service;
designing a method for classifying photovoltaic clusters that take into account the carbon flow and energy efficiency of the power system, and analyzing an impact of the photovoltaic cluster auxiliary service on the carbon flow and energy efficiency of the power system, calculating and obtaining a contribution of the photovoltaic cluster to carbon reduction and enhancement efficiency of the power system, to realize multi-scale carbon flow and energy efficiency optimization of the power system;
wherein the carbon flow calculation improvement model of the power system that takes into account the photovoltaic cluster auxiliary service comprises:
designing a multi-scale operation scenario of the power system that takes into account the photovoltaic cluster auxiliary service, designing three operation scenarios of a photovoltaic inverter and a static var generator (SVG) device based on light intensity, calculating and obtaining changes in a dynamic carbon flow of the power system before and after 24 hours of division of the photovoltaic cluster, and analyzing a supporting role of the photovoltaic cluster auxiliary service in the low-carbon operation of the power system;
equivalently transforming the power lossy transmission network of the system power to the lossless power consumption network, apportioning network loss generated by a power network operation to each node load, combining a carbon emission intensity per unit power of different generating units, and constructing a power vector matrix of each unit, to calculate a dynamic network loss corresponding to carbon emissions generated by different paths of the power system, and to realize an accurate calculation of the carbon flow of the power system and obtain carbon indexes of various links of the power system, to track a carbon footprint of the power system, to achieve an equivalent transformation of lossy and lossless networks;
calculating the carbon flow of the power system that takes into account the photovoltaic cluster auxiliary service, considering all branch trend distribution matrices, unit injection matrices, node flux matrices, carbon emission factors, real-time load values of nodes, and carbon emission intensity matrices of the generating units in the equivalent lossless network of the photovoltaic cluster auxiliary service, calculating and obtaining a carbon potential matrix of each node, to combine with equivalent node loads in the lossless power consumption network to calculate and obtain a carbon flow rate of loads and dynamic carbon emissions.

2. The method according to claim 1, wherein the decision-making system for low-carbon operation of the power system based on the coupling of electric-carbon energy efficiency comprises:
calculating and obtaining a correlation between electrical quantity and carbon flow of the power system based on the photovoltaic cluster auxiliary service; wherein an output varies in a range of 0-1, a larger value represents a stronger correlation between electrical-carbon energy efficiency; based on an electric-carbon energy efficiency index, a low-carbon operation efficiency index system is constructed for the power system, which provides a basis for an identification of low-carbon operation efficiency of the power system and low-carbon operation decision-making; and
designing a data envelopment analysis (DEA) three-stage low-carbon operation decision-making method based on an input-output dynamic feedback, comprising a system low-carbon operation efficiency identification, an elimination of influence of external environmental variables on operation efficiency of the power system, and a low-carbon operation analysis of the power system based on a DEA dynamic loop feedback.

3. The method according to claim 1, wherein designing the method for classifying the photovoltaic clusters that takes into account the carbon flow and energy efficiency of the power system comprises:
cluster classification indexes comprising: a regulation capacity of a photovoltaic generation system, a net load carbon flow rate, a node carbon potential, and an energy efficiency of the node;
wherein the photovoltaic power generation system regulation capacity contains an upper and lower limits of a reactive power regulation capacity of the photovoltaic power generation system, a grid-connected capacity of the photovoltaic inverter, and the upper limit of the photovoltaic active regulation capacity;
wherein a nodal net load is expressed as a difference between the node load correction value in the lossless equivalent network and an output value of a connected photovoltaic system, and the net load carbon flow rate is a product of the net load value and the node carbon potential;
dividing the photovoltaic system with close carbon potential of the nodes into the photovoltaic cluster, wherein the photovoltaic cluster is able to achieve a balanced distribution of carbon flows within the power system through the balancing of the node carbon potential, to effectively avoid the imbalance situation of carbon emissions;
dividing the photovoltaic power generation system with similar energy efficiency of the node into the photovoltaic cluster to fully understand the energy efficiency of each node in the photovoltaic cluster, to assist an energy planning of the power system and improve the overall energy utilization efficiency of the photovoltaic cluster;
establishing a node similarity matrix, photovoltaic access nodes within the same photovoltaic cluster having similar operating characteristics, by calculating and obtaining a similarity of the node's various indicators, to reflect a similarity of the operating characteristics of photovoltaic access nodes; and
using fast unfolding clustering algorithm for a division of photovoltaic clusters, using a modularity function as a basis for photovoltaic cluster division, wherein the larger the value of the modularity function, more reasonable results of the photovoltaic cluster division.

4. The method according to claim 1, wherein obtaining the impact of the photovoltaic cluster ancillary services on the carbon flow and energy efficiency of the power system, calculating and obtaining the contribution of the photovoltaic cluster to the carbon reduction and enhancement efficiency of the system comprises:
analyzing the impact of the photovoltaic cluster auxiliary service on the carbon flow of the power system using structural equation modeling (SEM), and obtaining a degree of indirect impact of the photovoltaic cluster auxiliary service on the carbon flow and energy efficiency of the power system through other variables;
for the 24-hour operation data of the power system, analyzing a dynamic change law between a carbon flow path coefficient, a total energy efficiency path coefficient and a system load curve, which is capable of clarifying a supportive role mechanism of the photovoltaic cluster auxiliary service on the carbon flow and energy efficiency of the power system, and the contribution of each photovoltaic cluster to the carbon reduction and enhancement efficiency of the power system, and is capable of making clear an amount of adjustment of the photovoltaic cluster auxiliary service that improves the ability of the power system to operate in a low-carbon and high-efficiency manner.
